(19) United States
(12) Patent Application Publication
(10) Pub. No.: US 2016/0019142 A1
(43) Pub. Date: Jan. 21, 2016

(54) Method of collecting garbage blocks in a solid state drive

(71) Applicant: QUANTA STORAGE INC., Taoyuan County (TW)

(72) Inventors: Cheng-Yi Lin, Taoyuan County (TW); Yi-Long Hsiao, Taoyuan County (TW)

(21) Appl. No.: 14/556,250

(22) Filed: Dec. 1, 2014

(30) Foreign Application Priority Data
Jul. 17, 2014 (CN) 201410341098.7

(51) Int. Cl. G06F 12/02; G06F 3/06

(52) U.S. Cl. CPC G06F 12/0253; G06F 12/0246; G06F 3/0608; G06F 3/064; G06F 3/0652; G06F 3/065; G06F 3/0679; G06F 2212/1044; G06F 2212/214; G06F 2212/253; G06F 2212/7205

(57) ABSTRACT

A method of collecting garbage blocks in a solid state drive includes collecting a garbage block of a multiple level cell flash memory, selecting a spare block as a target block, copying effective data of the garbage block to a physical cell of the target block, searching for unprogrammed physical pages of the physical cell of the target block, using dummy data to complete programming of the unprogrammed physical pages of the physical cell, deleting the effective data in the garbage block, and recycling the garbage block to be a new spare block.

### BACKGROUND OF THE INVENTION

1. Field of the Invention

The present invention presents a method of collecting garbage blocks in a solid state drive, and more particularly, a method of collecting garbage blocks in a solid state drive able to protect data from being lost when a malfunction occurs.

2. Description of the Prior Art

A solid state drive (SSD) is a memory device comprising of a plurality of non-volatile flash memories. A flash memory uses voltages for programming and accessing of data. When a malfunction occurs during programming, the data being stored may be damaged. Therefore, protecting the data from being lost during programming of the solid state drive is important.

When a solid state drive of prior art receives a command to access data, a logic mapping table is used such that the logic page address (LPA) being accessed is converted to a physical page address (PPA) and then transmitted to a flash memory. The flash memory has a data area and a spare area. Each area comprises a plurality of blocks. Each of the plurality of blocks comprises a plurality of pages. Data is deleted by block. The flash memory reads the data of the physical page address using the data physical block of the data area. After the data is transmitted to the server through the solid state drive, a spare block of the spare area is selected by the solid state drive. The updated data is then written to the spare block to form a new data physical block of the data area and change the logic mapping table. The data of the logic page address of the data physical block may be discarded by the program so that the garbage block collected is recycled to be reused.

FIG. 1 illustrates a flow chart of a method of collecting a garbage block in a solid state drive according to prior art. The method of the prior art comprises executing a program for collecting of the garbage block (step P1), collecting the discarded logical pages exceeding a predetermined number of a physical block of the data area to be a garbage block (step P2), selecting a spare block of the spare area to be a target block (step P3), copying effective data of the garbage block and programming the effective data to the target block (step P4), deleting the effective data of the garbage block after finishing copying effective data (step P5), and recycling the garbage block to be a new spare block of a spare area (step P6). Therefore, the solid state drive of the prior art can reorganize the effective data of the garbage block on to the target block and clear the physical block of the data area to be alternatingly used as a spare block.

However, the solid state drive of the prior art takes a single garbage block as a unit. After copying effective data of the garbage block to the target block, the deletion of the effective data of the garbage block is completed. When a malfunction such as power outage occurs during transmission of the effective data of the garbage block to the target block, the effective data already programmed into the physical pages of the target block is going to be damaged. Because the effective data of the damaged physical pages correspond to an already recycled garbage block, the deleted effective data are no longer recoverable and cause loss of data stored in the solid state drive. Therefore, there are still problems to solve in the process of collecting garbage blocks of solid state drive according to the method of the prior art.

### SUMMARY OF THE INVENTION

An objective of the present invention is to present a method of collecting garbage blocks in a solid state drive. After effective data are copied to a target block, dummy data are programmed to a physical cell not completely programmed before deleting effective data of a garbage block to protect the effective data.

Another objective of the present invention is to present a method of collecting garbage blocks in a solid state drive. When a malfunction occurs during programming of the dummy data, the effective data of the garbage block are copied to the target block to prevent loss of data.

To achieve the objective of the present invention, the method of collecting garbage blocks in a solid state drive of the present invention comprises executing a program for collecting of the garbage block when the solid state drive triggers collecting of the garbage block, collecting a garbage block of a data area of a multiple level cell flash memory, selecting a spare block of the multiple level cell flash memory as a target block, copying effective data of the garbage block and programming the effective data to physical pages of a physical cell of the target block, searching for unprogrammed physical pages of the physical cell of the target block, completing programming of the physical cell by programming the unprogrammed physical pages of the physical cell with dummy data, deleting the effective data in the garbage block, and recycling the garbage block to be a new spare block of a spare area of the multiple level cell flash memory.

The method of collecting the garbage blocks in the solid state drive of the present invention completes programming of the physical cell before deleting the effective data in the garbage block. When programming the dummy data, the programming of the unprogrammed physical pages of the physical cell is performed in an interchanging manner and according to a sequence of codes of physical pages of the target block. When a malfunction occurs during programming of the dummy data causing damage to the effective data programmed in the physical pages, the effective data of the garbage block are recopied and programmed to the target block and the physical pages programmed with dummy data and damaged effective data are discarded. After programming the unprogrammed physical pages of the physical cell of the target block with the dummy data, the garbage block is recycled and damaged dummy data in the physical cell are discarded.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flow chart of a method of collecting a garbage block in a solid state drive according to prior art.

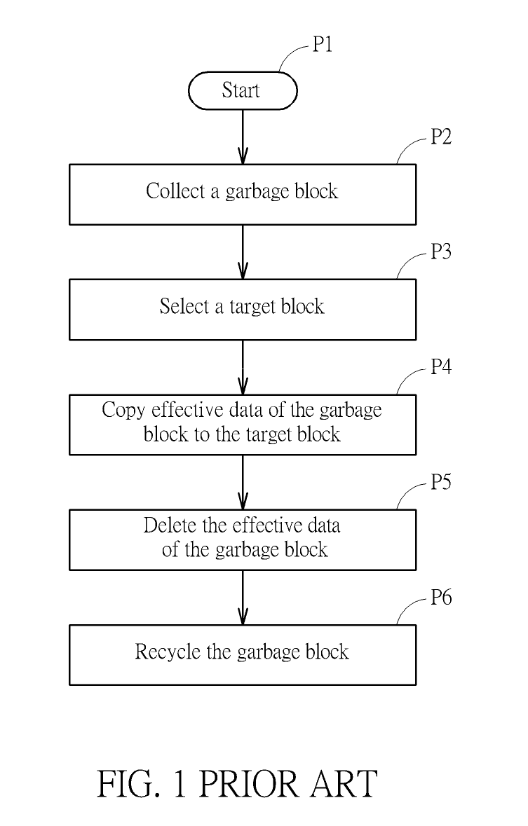

FIG. 2 illustrates a block diagram of a solid state drive according to an embodiment of the present invention.

FIG. 3 illustrates a block diagram of a physical block of a flash memory in FIG. 2.

FIG. 4 illustrates a diagram for programming the flash memory in FIG. 3.

FIG. 5 illustrates a diagram of the solid state drive in FIG. 2 executing a program for collecting of the garbage block.

FIG. 6 illustrates a flowchart of a method of collecting garbage blocks in a solid state drive according to an embodiment of the present invention.

FIG. 7 illustrates a diagram of the solid state drive when a malfunction occurs during execution of the program for collecting of the garbage block.

FIG. 8 illustrates a flowchart of a method of collecting garbage blocks in a solid state drive according to another embodiment of the present invention.

### DETAILED DESCRIPTION

To achieve the objective of the present invention, preferred embodiments of the present invention are described in the following paragraphs together with some illustrations.

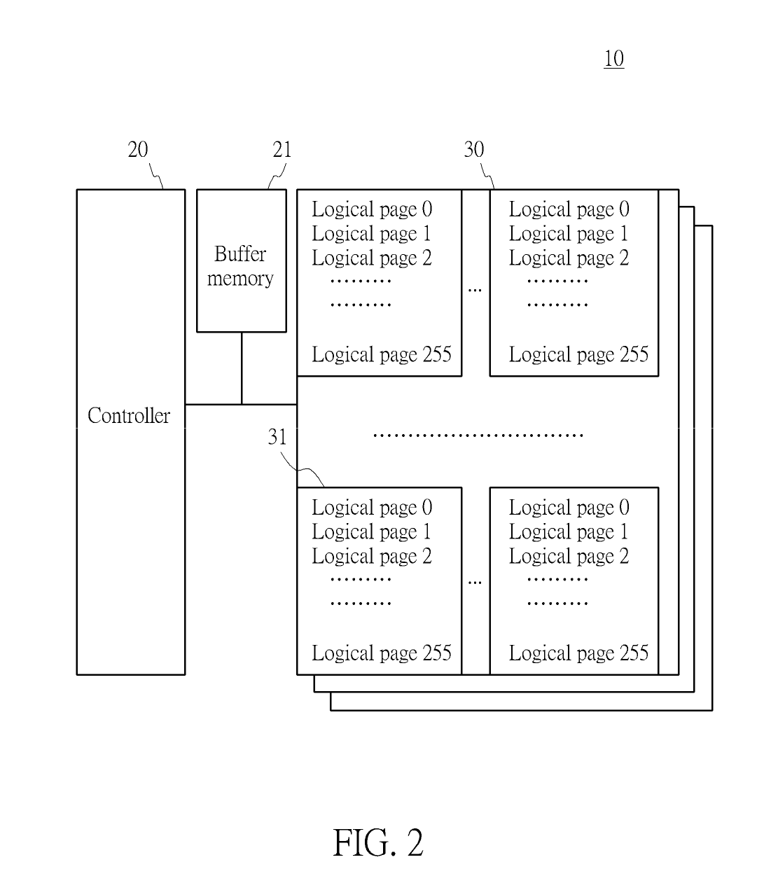

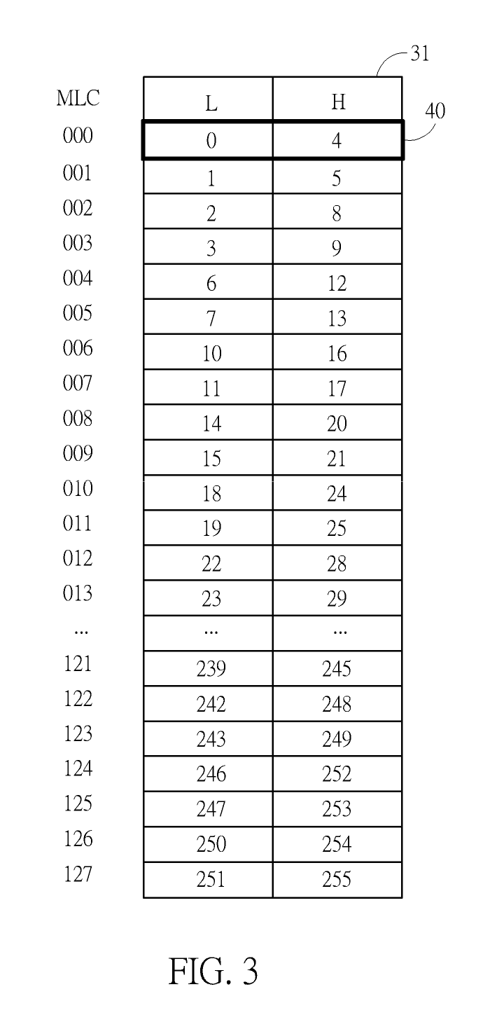

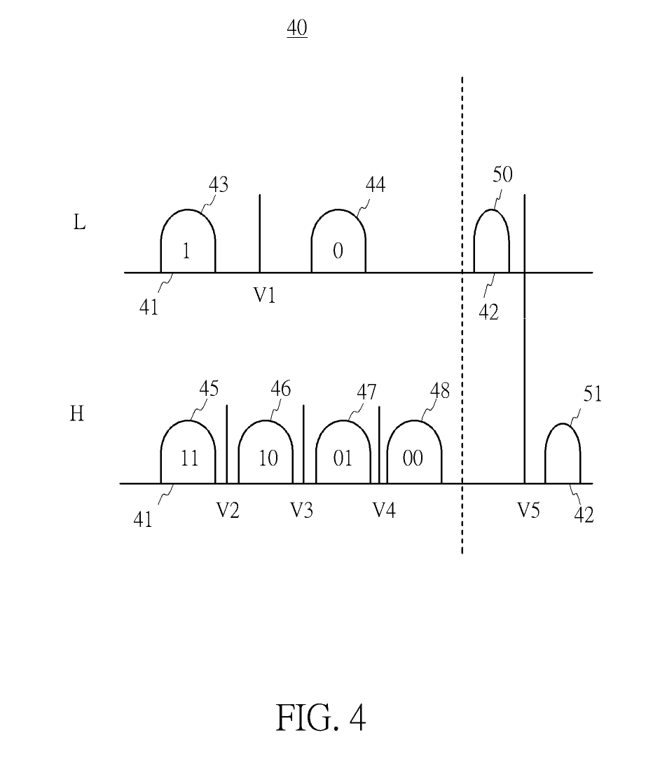

FIG. 2 illustrates a block diagram of a solid state drive 10 according to an embodiment of the present invention. FIG. 3 illustrates a block diagram of a physical block 31 of a flash memory 30 in FIG. 2. FIG. 4 illustrates a diagram for programming the flash memory 30 in FIG. 3. The solid state drive 10 in FIG. 2 may be a conventional solid state drive. The solid state drive 10 may comprise a controller 20, a buffer memory 21 and a flash memory 30. The controller 20 may be configured to coordinate the buffer memory 21 used to store a control parameter of the flash memory 30 and control a plurality of flash memory 30 used to store data to be accessed. The flash memory 30 may comprise a plurality of physical blocks 31. Each of the physical blocks 31 comprises 256 physical pages to store 256 logical page data.

The flash memory 30 may store data in memory cells. A flash memory may be a single level cell (SLC) device, a multi-level cell (MLC) device, a triple level (TLC) device, and a quad level (QLC) device, etc. The flash memory 30 of the present invention may be a multi-level cell (MLC) device. Although the embodiment describes a multi-level cell flash memory, the present invention is not limited to the multi-level cell flash memory. The multi-level cell (MLC) flash memory 30 may comprise of an upper level cell and a lower level cell. Adjacent and simultaneously accessible physical pages may be set as a physical cell 40. And the 128 physical cells 40 of the flash memory 30 may be coded 000 to 127 and may be divided into physical blocks 31 to store 256 logical page data. To prevent programming voltage from affecting voltages of already programmed adjacent physical pages, when programming the multi-level cell (MLC) flash memory 30, programming of logical page data to physical pages may be done according to a sequence of codes of physical pages and in an interchanging manner. The mapping table used to correspond the addresses of the 256 physical pages of each physical block 31 of the multi-level cell (MLC) flash memory 30 and the addresses of the 256 logical page data may be formed and stored in the buffer memory 21.

The physical cell 40 in FIG. 4 may comprise a lower page L and a higher page H. Each physical page may comprise a plurality of memory devices 41. A memory device 41 may load different voltages used to represent different digital signals. The physical cell 40 may further comprise a flag device 42 used to load different voltages used as a flag for indicating the number of times the physical cell 40 may be programmed, such as to represent a single programming or a double programming.

The multi-level cell (MLC) flash memory 30 may program a logical page data 0 and a logical page data 4 to the physical cell 40. Before programming the physical cell 40, the voltage of the memory device of the physical cell 40 may be maintained on erase voltage and the flag device 42 may be maintained to indicate single programming using the flag voltage 50. For single programming, by inputting the predetermined voltage to the lower page L of the physical cell 40, the memory device 41 may be formed to have an erase voltage 43 and a single programming flag voltage 50 with different loads and the flag voltage 50 of the flag device 42 may represent a single programming to program the logical page data 0 to the lower page L. For double programming, by adding the predetermined voltage to the flag voltage representing the single programming of the higher page H of the physical cell 40, the higher page H of the memory device 41 may be formed to load different double programming voltages 45, 46, 47, and 48 and the flag device 42 may increase the flag voltage to represent a double programming flag voltage 51 to program the logical page data 4 to the higher page H. When reading data, different predetermined threshold voltages V1-V5 may be used to distinguish the magnitude of the voltage of each memory device 41 and distinguish the bits 1 and 0 of the digital signal to read the logical page data 0 and the logical page data 4 stored in the lower page L and higher page H.

The multi-level cell (MLC) flash memory 30 may prevent damages to the memory caused by excessive amount of voltage by performing successive increment of voltage magnitude during programming of the adjacent physical pages. When a malfunction such as power outage occurs during programming of higher pages H, voltages of the memory device 41 and the flag device 42 may not be able to reach a predetermined voltage. Thus, the predetermined voltage may not be used to distinguish the magnitude of the voltage of each memory device 41 and the adjacent pages may not be able to read the logical page data 0 and the logical page data 4, resulting to the loss of data.

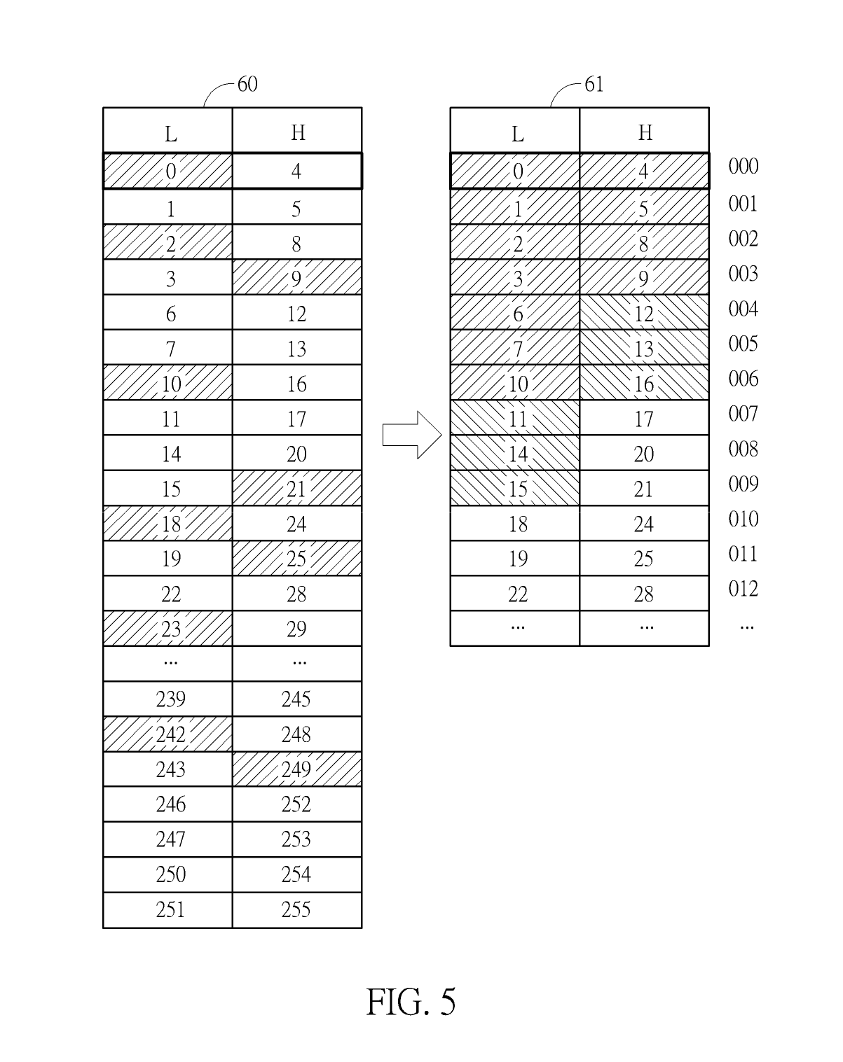

FIG. 5 illustrates a diagram of the solid state drive in FIG. 2 executing a program for collecting of the garbage block. When the solid state drive is executing a program for collecting of the garbage block, a spare block of a spare area may be selected to be a target block 61 to correspond to the garbage block 60 collected. The effective data of the garbage block 60 may be copied sequentially to the physical pages of the target block 61. For example, the logical page data 0-2-9-10-17-18-21-23-25-242-249 marked in the garbage block 60 may be copied to be the logical page data 0-1-2-3-4-5-6-7-8-9-10 marked in the target block 61. The target block 61 may be programmed in an interchanging manner and according to a sequence of codes of the physical pages. In the process of copying effective data, the physical pages of the physical cell may not be completely filled. For example, the physical cells 004, 005, and 006 shown in FIG. 5 may only be filled with the logical page data 6, 7, and 10.

To avoid loss of data when a malfunction occurs, before deleting the effective data in the garbage block, the target block 61 having physical cell programmed with effective data may be searched for unprogrammed physical pages such as the physical cells 004, 005, and 006. Dummy data may be used to program the unprogrammed physical pages in an interchanging manner and according to a sequence of codes of the physical pages of the target block to complete programming up to the higher page H of the physical cell 006. The dummy data may be predetermined data. Thus, the logical page data 11 to 16 marked in FIG. 5 may be dummy data. The unprogrammed physical pages of physical cells 004, 005, 006 may be programmed with dummy data before deleting the effective data from the garbage block 60 and recycle the garbage block 60. Thus, the effective data programmed in the physical pages may not be damaged when effective data from another garbage block are being programmed to higher level cells.

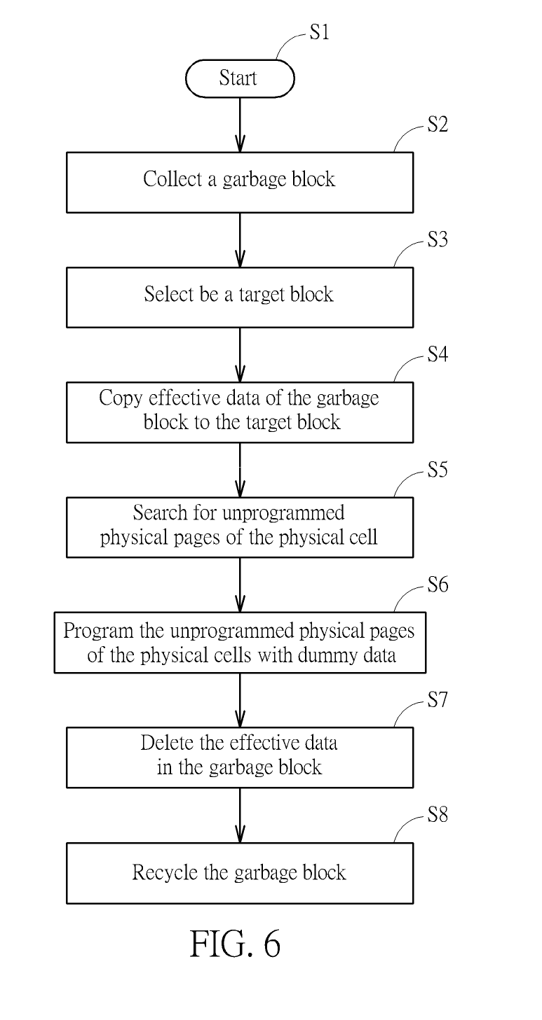

FIG. 6 illustrates a flowchart of a method of collecting garbage blocks in a solid state drive according to an embodiment of the present invention. The method of collecting garbage blocks in the solid state drive may comprise executing a program for collecting of the garbage block when the solid state drive triggers collecting of the garbage block (step S1), collecting the discarded logical pages exceeding a predetermined number of a physical blocks of the data area of a multi-level cell (MLC) flash memory to be a garbage block (step S2), selecting a spare block of a spare area of the flash memory to be a target block (step S3), copying effective data of the garbage block and programming the effective data to physical pages of physical cells of the target block (step S4), searching the physical cells of the target block having physical pages programmed with effective data for unprogrammed physical pages of the physical cell (step S5), completing programming of the physical cells by programming the unprogrammed physical pages of the physical cells with dummy data (step S6), deleting the effective data in the garbage block (step S7), and recycling the garbage block to be a new spare block of a spare area (step S8).

Therefore, the method of collecting garbage blocks in the solid state drive may be able to copy the effective data to the target block when executing the program for collecting of the garbage block. The dummy data may be used to completely program the physical cell before deleting effective data from the garbage block to protect the effective data of the physical cells from damages. After recycling the garbage block, no more programming may be executed on the corresponding physical cells to avoid any damages to the effective data and, thus, achieving the objective of protecting effective data.

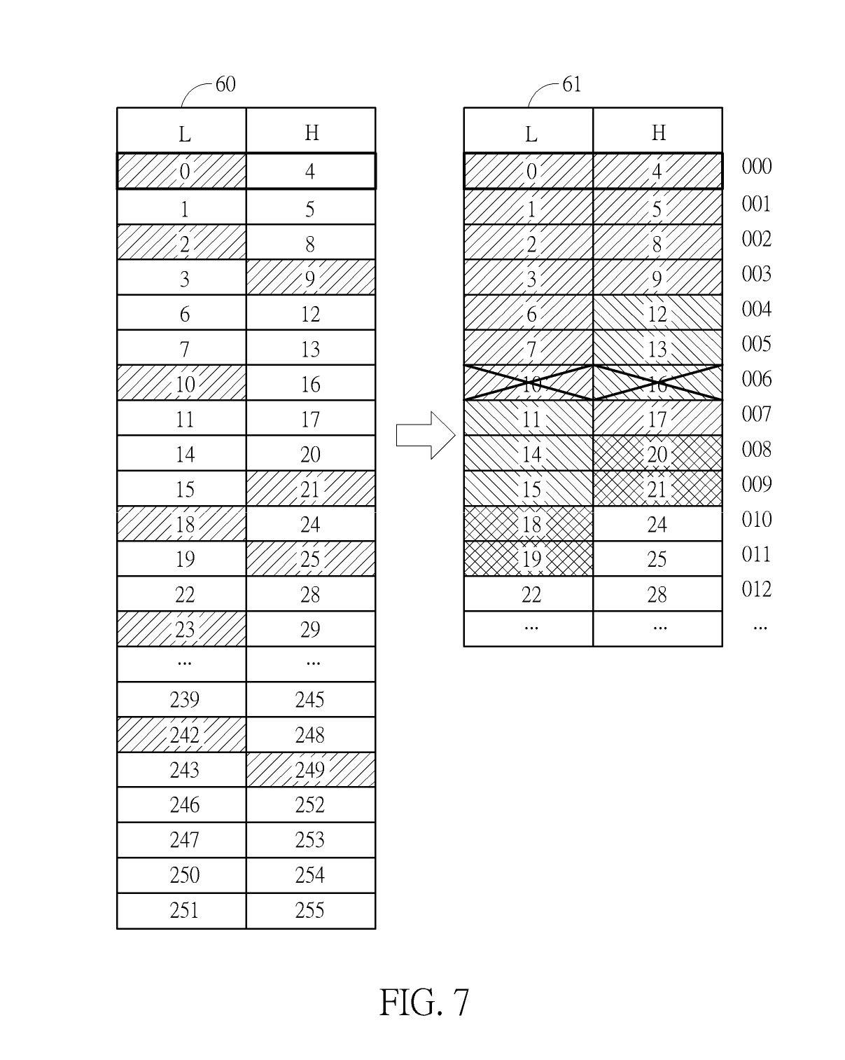

FIG. 7 illustrates a diagram of the solid state drive when a malfunction occurs during execution of the program for collecting of the garbage block. When a malfunction occurs during programming of dummy data, the already programmed effective data may be damaged. For example, when a malfunction occurs during programming a logical page data 16 to the higher page H of the physical cell 006 of the target block 61, a logical page data 10 programmed in the lower page L of the physical cell 006 may be damaged. To complete the programming of the physical cell 006, the effective data not yet erased from the garbage block 60 may be copied again. The logical page data 249 of the garbage block 60 supposed to be copied to be the logical page data 10 may be copied again and programmed to the higher page H of the physical cell 007 of the target block 61 to form logical page data 17. The target block 61 may be searched again for unprogrammed physical pages. If the target block 61 is determined to be completely programmed, the effective data in the garbage block 60 may be deleted.

The logical page data 11 to 16 of the target block 61 may be dummy data and logical page data 14 and 15 may be programmed in the physical cells 008 and 009. The physical cells 008 and 009 may not be completely programmed. In the process of recycling another garbage block, logical page data 18 to 21 marked in FIG. 7 may be programmed. If a malfunction occurs during programming of logical pages 20 and 21 damaging logical page data 14 and 15, the logical page data 14 and 15 may be directly discarded without recovering. Because the logical page data 14 and 15 are dummy data, the solid state drive shall not lose any data.

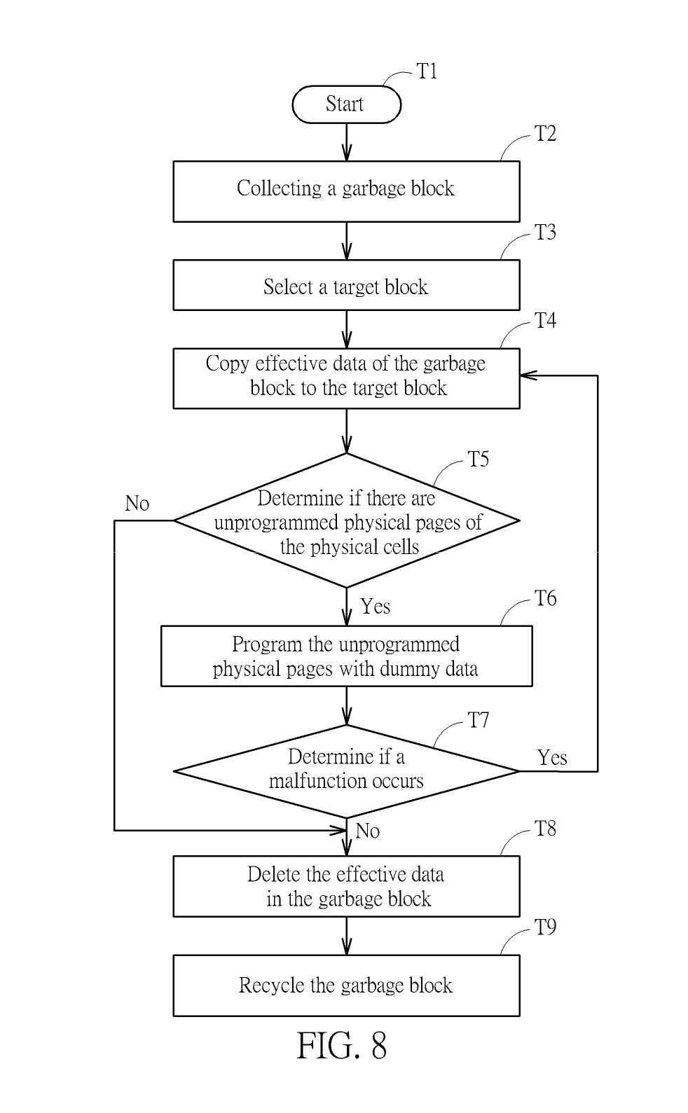

FIG. 8 illustrates a flowchart of a method of collecting garbage blocks in a solid state drive according to another embodiment of the present invention. The method of collecting garbage blocks in the solid state drive may comprise executing a program for collecting of the garbage block (step T1), collecting the discarded logical pages exceeding a predetermined number of a physical block of the data area of a multi-level cell (MLC) flash memory to be a garbage block (step T2), selecting a spare block of a spare area to be a target block (step T3), copying effective data of the garbage block and programming the effective data to physical pages of physical cells of the target block (step T4), searching for unprogrammed physical pages of the physical cells of the target block (step T5), if there are no unprogrammed physical pages in the physical cells, deleting the effective data in the garbage block (step T8), if there are unprogrammed physical pages in the physical cells, programming the unprogrammed physical pages of the physical cells with dummy data (step T6), determining if a malfunction occurs during programming of the dummy data (step T7), if a malfunction occurs, copying the effective data of the garbage block again (return to step T4), if no malfunction occurs, deleting the effective data in the garbage block (step T8), and recycling the garbage block to be a new spare block of a spare area (step T9).

Therefore, the method of collecting garbage blocks in the solid state drive may copy effective data from garbage blocks not yet deleted and reprogram the copied effective data to the target block when a malfunction occurs during programming of dummy data causing damage to the already programmed effective data to achieve the objective of preventing the solid state drive from losing data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of collecting garbage blocks in a solid state drive, comprising:
collecting a garbage block of a data area of a multiple level cell flash memory;
selecting a spare block of the multiple level cell flash memory as a target block;
copying effective data of the garbage block and programming the effective data to physical pages of a physical cell of the target block;
searching for unprogrammed physical pages of the physical cell of the target block;
completing programming of the physical cell by programming the unprogrammed physical pages of the physical cell with dummy data;
deleting the effective data in the garbage block; and
recycling the garbage block to be anew spare block of a spare area of the multiple level cell flash memory.

2. The method of claim 1, further comprising the multiple level cell flash memory grouping adjacent and simultaneously accessible physical pages into a physical cell.

3. The method of claim 1, further comprising when the solid state drive triggers collecting of the garbage block, executing a program for collecting of the garbage block.

4. The method of claim 1, wherein completing programming of the physical cell is performed before deleting the effective data in the garbage block.

5. The method of claim 4, wherein after programming the unprogrammed physical pages of the physical cell of the target block with the dummy data, recycling the garbage block and discarding damaged dummy data in the physical cell.

6. The method of claim 1, wherein the dummy data are predetermined data.

7. The method of claim 6, wherein when programming the dummy data, performing programming the unprogrammed physical pages of the physical cell in an interchanging manner and according to a sequence of codes of physical pages of the target block.

8. The method of claim 1, wherein when a malfunction occurs during programming of the dummy data causing damage to the effective data programmed in the physical pages, copying the effective data of the garbage block and programming the effective data to the target block.

9. The method of claim 8, wherein when the malfunction occurs during programming of the dummy data, the physical pages programmed with dummy data and damaged effective data are discarded.
